(19) United States
(12) Patent Application Publication
(10) Pub. No.: US 2025/0038346 A1
(43) Pub. Date: Jan. 30, 2025

(54) RECHARGEABLE ENERGY STORAGE SYSTEM WITH A UNIFIED CELL HOLDER VENT TRAY AND VENT TRAY COVER SYSTEM

(71) Applicant: GM GLOBAL TECHNOLOGY OPERATIONS LLC, Detroit, MI (US)

(72) Inventors: Mohammad Hamza KIRMANI, Troy, MI (US); Kyie James CLARE, Brighton, MI (US); Ryan Patrick HICKEY, Austin, TX (US); Tyler TALASKI, Clarkston, MI (US); Anthony Michael COPPOLA, Rochester Hills, MI (US); Michael Victor PYRTKO, Femdale, MI (US); Xiaosong HUANG, Novi, MI (US); Evan David GRIFFITH, Pleasant Ridge, MI (US); Daniel Michael WANG, Royal Oak, MI (US)

(21) Appl. No.: 18/359,347

(22) Filed: Jul. 26, 2023

(51) Int. Cl. H01M 50/342; H01M 50/204; H01M 50/249

(52) U.S. Cl. CPC H01M 50/3425; H01M 50/204; H01M 50/249; H01M 2220/20

(57) ABSTRACT

A battery pack for a vehicle includes a housing including at least one pack vent between an interior and an exterior of the housing. A plurality of battery cells are contained within the housing. A channel tray includes channel arrays having a plurality of vent openings each positioned in connection with a vent on each of the plurality of battery cells. The channel arrays are in connection with the at least one vent of the housing, wherein the channel system is enclosed from the rest of the volume of the pack and the plurality of vent openings are each provided with a vent cover.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Ventilating the battery cells of a battery pack for an electric vehicle is known in the art. The vent system must remain open for gas to traverse during a thermal event so that the gas is able to reach the pack's vent port. The rest of the pack is commonly filled with potting resin (foamed or non-foamed) for electrical isolation, structural performance and thermal insulation. Controlling the position of the potting is challenging. The variability of foam expansion makes the baseline system incompatible with foam potting.

The present disclosure relates to a battery cell array to pack thermal runaway gas venting system using mid pack channel system.

### SUMMARY

The main objective of the present disclosure is to create a closed volume for the thermal runaway gas vent system. This closed volume cannot be blocked by potting during manufacturing.

According to an aspect of the present disclosure, a battery pack for a vehicle includes a housing including at least one pack vent between an interior and an exterior of the housing. A plurality of battery cells are contained within the housing. A channel tray includes channel arrays having a plurality of vent openings each positioned in connection with a vent on each of the plurality of battery cells. The channel arrays are in connection with the at least one vent of the housing, wherein the channel system is enclosed from the rest of the volume of the pack and the plurality of vent openings are each provided with a vent cover.

According to a further aspect, the housing contains a potting material encapsulating the plurality of battery cells.

According to a further aspect, the potting material is one of a foaming resin, a non-foaming resin or a combination of foaming resin and non-foaming resin.

According to a further aspect, the vent covers are configured to rupture in response to a thermal event of the battery cells.

According to a further aspect, the vent covers are flame resistant.

According to a further aspect, the vent covers are integrally formed with the battery cell engagement panels.

According to a further aspect, the vent covers are connected to the battery cell engagement panels by areas of weakened material.

According to a further aspect, the vent covers are electrically insulating.

According to a further aspect, the vent covers are made from a material including one of PA 66, PA6, PP, PU, epoxy, silicone, PE, mica, PS, PVC, ABS, PET, POM, PTFE, PMMA, PC, fiberglass containing plastics, and flame retardant containing plastics.

According to a further aspect, the vent covers are made using PA 66 containing up to 50% glass fiber.

According to a further aspect, the vent covers are made from a foam.

According to a further aspect, the vent covers include individual cell covers.

According to a further aspect, the vent covers are formed as a strip of vent covers.

According to a further aspect, the channel tray includes a battery cell engagement panel and a tray panel, the battery cell engagement panel includes the plurality of vent openings therein.

According to a further aspect, the housing includes a bottom shear plate and an upper shear plate, the battery cell engagement panel and the tray panel include injection channels extending therethrough, wherein the injection channels are configured to allow a potting to be injected through the injection channels and between the bottom shear plate and the tray panel.

According to a further aspect, the housing contains a potting material encapsulating the plurality of battery cells and the channel tray and is bonded to the bottom shear plate and the upper shear plate.

According to another aspect, a battery pack for a vehicle includes a housing including at least one pack vent between an interior and an exterior of the housing. A plurality of battery cells are contained within the housing. A channel tray includes channel arrays having a plurality of vent openings each positioned in connection with a vent on each of the plurality of battery cells and the channel arrays are in connection with the at least one vent of the housing. The channel system is enclosed from the rest of the volume of the pack and the plurality of vent openings are each provided with a vent cover, wherein the channel tray includes a plurality of panel assemblies each including a battery cell engagement panel and a tray panel, the battery cell engagement panels include the plurality of cell vent openings therein, the plurality of panel assemblies including having male engagement portions engaged with female engagement portions of an adjacent panel assembly.

According to a further aspect, the housing includes a bottom shear plate and an upper shear plate, the battery cell engagement panel and the tray panel include injection channels extending therethrough, wherein the housing contains a potting material encapsulating the plurality of battery cells and the channel tray and is bonded to the bottom shear plate and the upper shear plate.

According to another aspect, a battery pack for a vehicle includes a housing including at least one pack vent between an interior and an exterior of the housing. A plurality of battery cells disposed within the housing. A channel tray includes channel arrays having a plurality of vent openings each positioned in connection with a vent on each of the plurality of battery cells and the channel arrays are in connection with the at least one vent of the housing, wherein the channel system is enclosed from the rest of the volume of the pack and the plurality of vent openings are each provided with a vent cover, wherein the housing includes a bottom shear plate and an upper shear plate, wherein the housing contains a potting material encapsulating the plurality of battery cells and the channel tray and is bonded to the bottom shear plate and the upper shear plate.

According to a further aspect, the housing includes a bottom shear plate and an upper shear plate, the battery cell engagement panel and the tray panel include injection channels extending therethrough, wherein the injection channels are configured to allow a potting to be injected through the injection channels and between the bottom shear plate and the tray panel.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a partial cross-sectional view of a battery pack having a vent system according to the principles of the present disclosure;

FIG. 2 is a schematic view of a battery pack having a vent system with a channel array connecting each battery cell to a master channel;

FIG. 3 is a detailed view of an alternative connection between the channel array and the pack vent manifold;

FIG. 4 is a schematic view of the integrally formed vent covers of the battery cell engagement panels;

FIG. 5 is a schematic view of the separately formed vent covers;

FIG. 6 is a schematic view of a strip of separately formed vent covers;

FIG. 7 is a bottom plan of a battery cell engagement panel with injection channels;

FIG. 8 is a schematic view of the injection channels in the channel array;

FIG. 9 is a schematic view of the potting encapsulating the battery cells and the channel array and bonded to the upper shear plate and the bottom shear plate;

FIGS. 10a and 10b illustrate a process for forming the channel array according to the principles of the present disclosure;

FIG. 11 is a schematic view of an interconnection between panel assemblies; and

FIG. 12 is a schematic view of an alternative interconnection between the panel assemblies.

In the drawings, reference numbers may be reused to identify similar and/or identical elements.

### DETAILED DESCRIPTION

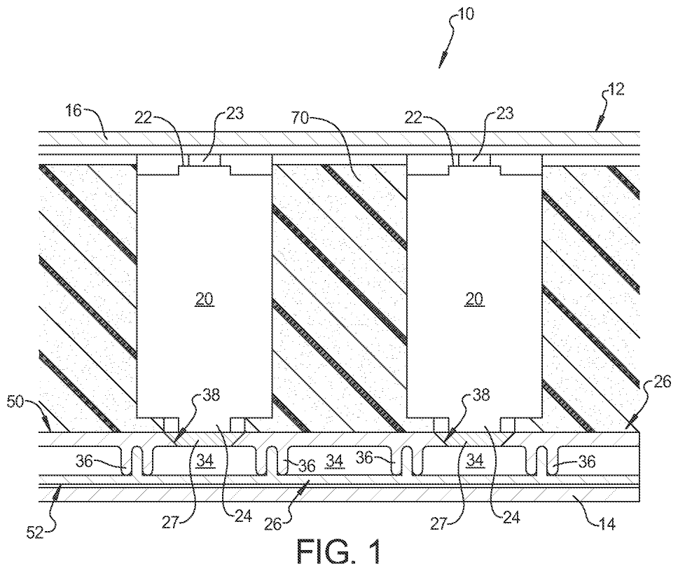

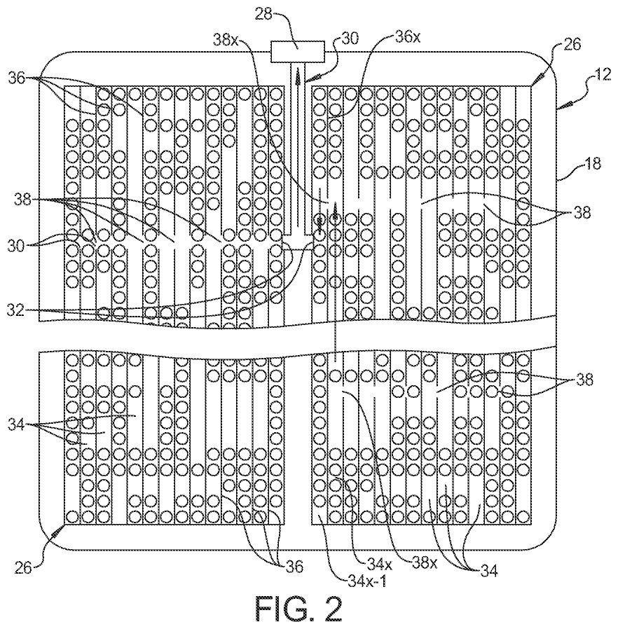

With reference to FIG. 1, a battery pack 10 is schematically shown including a housing 12 having a bottom shear plate 14, a top shear plate 16 and a sidewall enclosure 18 (see FIG. 2). A plurality of battery cells 20 are disposed within the housing 12. The battery cells 20 each include electric terminals 22 for connection to a bus bar or other system 23 for electrical connection. The battery cells 20 are supported by a channel array 26. The channel array 26 includes a plurality of battery cell engagement panels 50 supported above a plurality of tray panels 52. The battery cell engagement panels 50 include vent openings 38 associated with each of the plurality of battery cells 20. A series of ribs 36 can be formed on either or both of the battery cell engagement panels 50 and the tray panels 52 to define channels 34 between the battery cell engagement panels 50 and the tray panels 52. The battery cells 20 each include a vent 24 in communication with a respective one of the openings 38 through a cell vent cover 27 that is one of breakable, rupturable, tearable, meltable or otherwise openable in response to a battery cell thermal event. The cell vent covers 27 are configured or made from a material such that the cell vent cover 27 should rupture in response to a thermal event of the battery cell 20 disposed against the vent cover and should absorb or consume enough energy in the process that the neighboring cells or any other vent covers are not ruptured. The cell vent covers 27 can be made from a material including one of PA 66, PA6, PP, PU, epoxy, silicone, PE, mica, PS, PVC, ABS, PET, POM, PTFE, PMMA, PC, fiberglass containing plastics, and flame retardant containing plastics although other materials can be used. By way of non-limiting example, the cell vent covers 27 can be made using PA 66 containing up to 50% glass fiber. A potting material 70 can encapsulate the battery cells 20.

As shown in FIG. 2, the channel array 26 can connect the vent 24 of each of the battery cells 20 to a pack vent 28 provided in the housing 12 via a master channel 30 that connects an outlet port 32 of the channel array 26 with the pack vent 28. The channel array 26 includes a plurality of channels 34 separated by a series of ribs 36 that include openings 38 for communicating the vent 24 of each battery cell 20 with the outlet port 32 of the channel array 26.

By way of example, as shown in FIG. 2, the vent from the battery cell 20x communicates through a channel 34x, through opening 38x in rib 36x and to channel 34x-1 to the outlet port 32 as indicated by the direction arrows. As shown in FIG. 2, the ribs 36 include openings 38 to allow the vent 24 of each battery cell 20 to communicate through and across the channels 34 to the outlet port 32. The channels 34 and the openings 38 can be provided with numerous alternative arrangements for communicating gasses from the battery cells 20 to the outlet port 32. The system easily enables a longer gas travel path to enable the gas temperature to be reduced prior to the gas exiting the pack.

Alternatively, with reference to FIG. 3, a channel array manifold 42 can connect the channels 34 to a pack vent manifold 44 which includes connector passages 46, 48 that communicate with the pack vent 28.

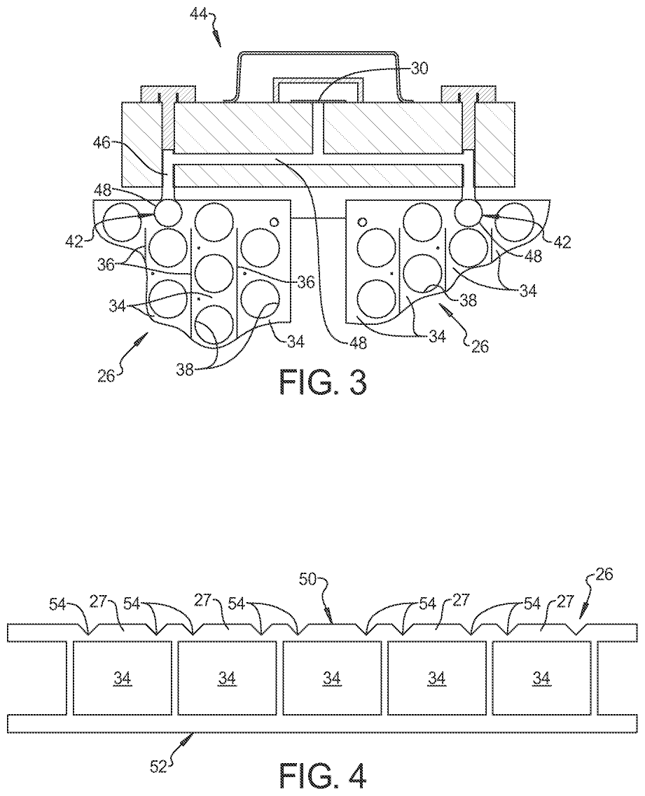

With reference to FIG. 4, the cell vent covers 27 can be formed integral with the battery cell engagement panels 50 wherein regions of thin or weakened material 54 can support the cell vent covers 27 within the openings 38 of the battery cell engagement panels 50. The regions of thin or weakened material 54 can be configured to rupture or break away in response to a battery cell thermal event.

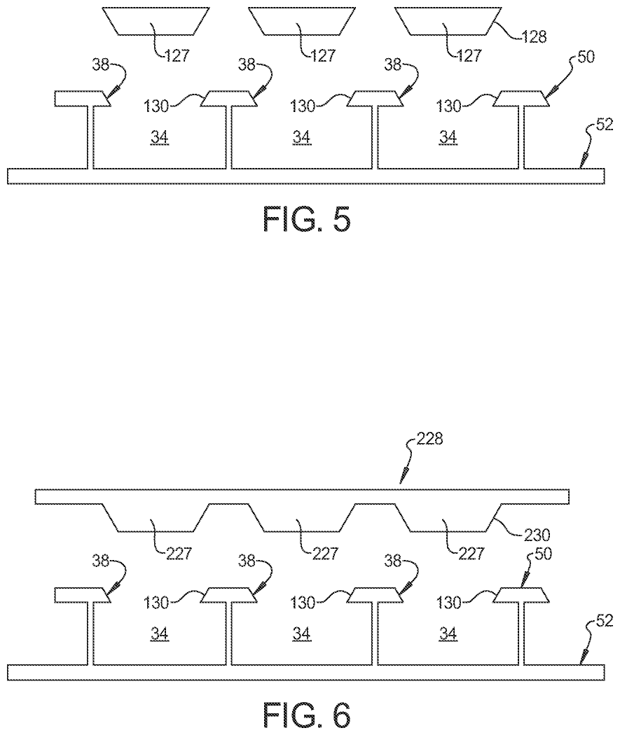

With reference to FIG. 5, the cell vent covers 127 are shown as being formed separate from the battery cell engagement panels 50 and placed in the openings 38. The cell vent covers 127 include tapered exterior sidewall 128 that engage a tapered interior sidewall 130 of the openings 38 in the battery cell engagement panels 50. The cell vent covers 127 can be made from a material including one of PA 66, PA6, PP, PU, epoxy, silicone, PE, mica, PS, PVC, ABS, PET, POM, PTFE, PMMA, PC, fiberglass containing plastics, and flame retardant containing plastics. By way of non-limiting example, the cell vent covers 127 can be made using PA 66 containing up to 50% glass fiber. The cell vent covers 127 are configured to be bent, broken or otherwise pressed through the openings in response to a thermal event of the battery cell 20.

With reference to FIG. 6, a strip 228 of cell vent covers 227 is shown with the cell vent covers 227 connected to one another. The strip 228 is formed separate from the battery cell engagement panels 50 and is placed so that the cell vent covers 227 are disposed in the openings 38. The cell vent covers 227 can include a tapered exterior sidewall 230 that engage a tapered interior sidewall 232 of the openings 38 in the battery cell engagement panels 50. The cell vent covers 227 can be made from a material including one of PA 66, PA6, PP, PU, epoxy, silicone, PE, mica, PS, PVC, ABS, PET, POM, PTFE, PMMA, PC, fiberglass containing plastics, and flame retardant containing plastics. By way of non-limiting example, the cell vent covers 227 can be made using PA 66 containing up to 50% glass fiber. The cell vent covers 227 are configured to break from the strip 228 and can be broken, bent or otherwise pressed through the openings 38 in response to a thermal event of the battery cell 20.

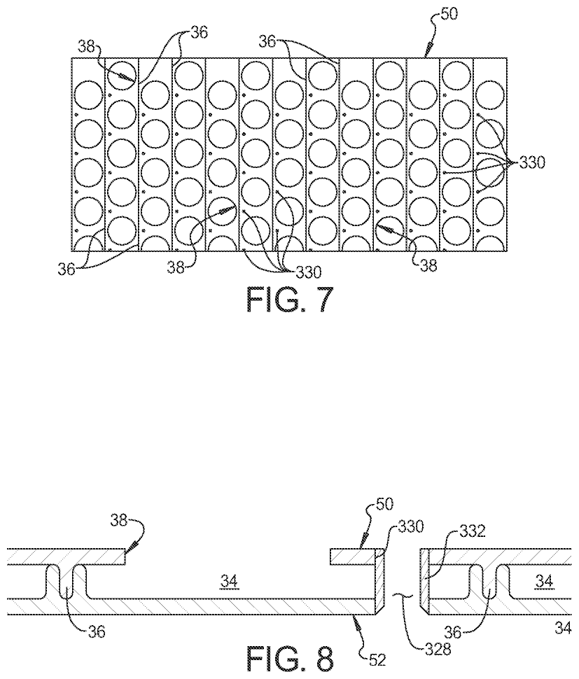

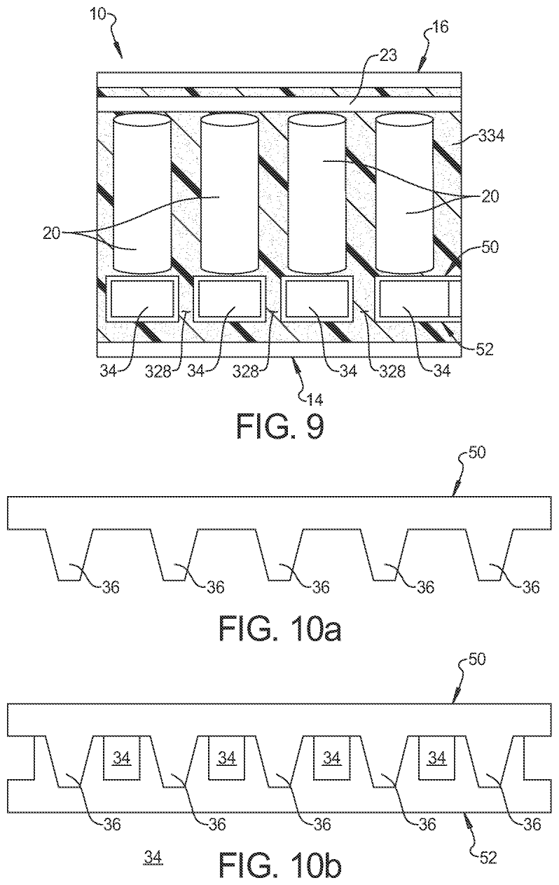

With reference to FIGS. 7-9, the channel array 326 can include passages 328 that pass through the battery cell engagement panels 50 and the tray panels 52. The passages 328 can be circular as shown in FIGS. 7 and 8 and are configured to allow a potting to be injected through the passages 328 and between the bottom shear plate and the tray panel. The passages 328 can be formed separate from or integrally within the ribs 36. As shown in FIG. 7, the battery cell engagement panel 50 includes apertures 330 that can receive a fitting 332 (Best shown in FIG. 8) that is connected to the tray panel 52 for isolating the passages 328 from the channels 34. As shown in FIG. 9, a schematic cross-sectional view of the battery housing is shown including a channel array 326 having elongated passages 328′ therethrough that allow the potting 334 to pass through the channel array and fill the area under the channel array 326. The elongated passages 328′ can be formed between a pair of ribs 36 extending from either of the battery cell engagement panels 50 or the tray panels 52 and in communication with an elongated opening 340 on the other of the battery cell engagement panels 50 and the tray panels 52. The potting 334 can be bonded to the bottom shear plate 14 and the top shear plate 16 while encapsulating the channel array and the battery cells 20. Thus, the potting 334 can interconnect the bottom shear plate 14 to the top shear plate 16.

With reference to FIGS. 10a and 10b, the battery cell engagement panels 50 can be formed to have raised ribs 36 and the tray panels 52 can be molded onto the battery cell engagement panels 50 so as to provide a sealed engagement with the raised ribs 36. During molding, the channels 34 can be formed by core elements that can be dissolved or otherwise removed to define the channels 34.

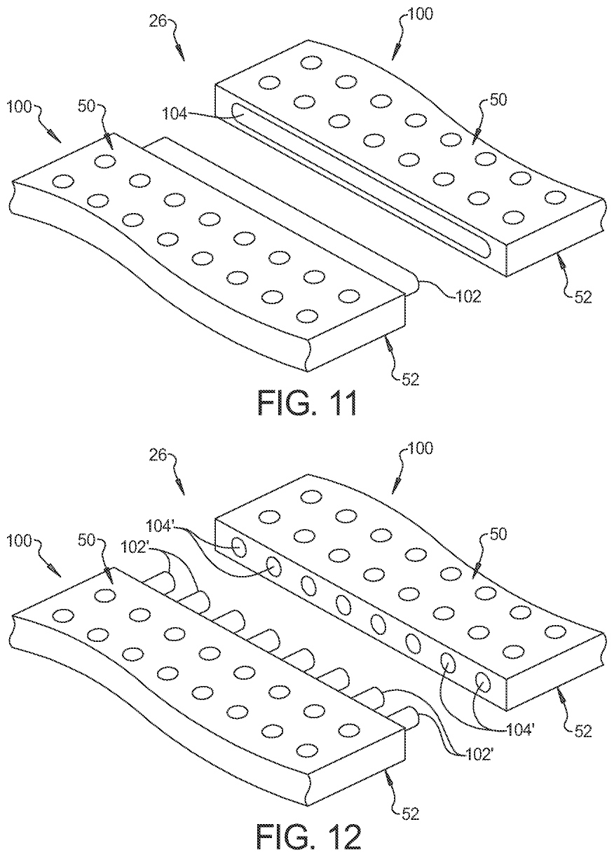

With reference to FIG. 11, the channel arrays 26 can be formed by a plurality of panel assemblies 100 each including a battery cell engagement panel 50 and a tray panel 52 that can be interconnected together. The panel assemblies 100 are laid side by side. The panel assemblies 100 include a male engagement portion 102 on one side edge and a female engagement portion 104 of a second edge, wherein the male engagement portion 102 of a panel assembly 100 is engaged with a female engagement portion 104 of an adjacent panel assembly 100 in order to connect the channels 34. The channels 34 can be formed with a single male engagement portion 102 and female engagement portions 104 or alternatively with their own male engagement portions 102′ and a single female engagement portions 104′, as shown in FIG. 12. Seals around the male engagement portion and an interlock between adjacent panel assemblies 100 can be used to enhance the sealed engagement between the panel assemblies 100.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery pack for a vehicle, comprising:
a housing including at least one pack vent between an interior and an exterior of the housing;
a plurality of battery cells disposed within the housing; and
a channel tray including channel arrays having a plurality of vent openings each positioned in connection with a vent on each of the plurality of battery cells and the channel arrays are in connection with the at least one vent of the housing, wherein the channel system is enclosed from the rest of the volume of the pack and the plurality of vent openings are each provided with a vent cover.

2. The battery pack for a vehicle according to claim 1, wherein the housing contains a potting material encapsulating the plurality of battery cells.

3. The battery pack for a vehicle according to claim 2, wherein the potting material is one of a foaming resin, a non-foaming resin or a combination of foaming resin and a non-foaming resin.

4. The battery pack for a vehicle according to claim 1, wherein the vent covers are configured to rupture in response to a thermal event of the battery cells.

5. The battery pack for a vehicle according to claim 1, wherein the vent covers are flame resistant.

6. The battery pack for a vehicle according to claim 1, wherein the vent covers are integrally formed with the battery cell engagement panels.

7. The battery pack for a vehicle according to claim 1, wherein the vent covers are connected to the battery cell engagement panels by areas of weakened material.

8. The battery pack for a vehicle according to claim 1, wherein the vent covers are electrically insulating.

9. The battery pack for a vehicle according to claim 1, wherein the vent covers are made from a material including one of PA 66, PA6, PP, PU, epoxy, silicone, PE, mica, PS, PVC, ABS, PET, POM, PTFE, PMMA, PC, fiberglass containing plastics, and flame retardant containing plastics.

10. The battery pack for a vehicle according to claim 1, wherein the vent covers are made using PA 66 containing up to 50% glass fiber.

11. The battery pack for a vehicle according to claim 1, wherein the vent covers are made from a foam.

12. The battery pack for a vehicle according to claim 1, wherein the vent covers include individual cell covers.

13. The battery pack for a vehicle according to claim 1, wherein the vent covers are formed as a strip of vent covers.

14. The battery pack for a vehicle according to claim 1, wherein the channel tray includes a battery cell engagement panel and a tray panel, the battery cell engagement panel includes the plurality of vent openings therein.

15. The battery pack for a vehicle according to claim 14, wherein the housing includes a bottom shear plate and an upper shear plate, the battery cell engagement panel and the tray panel include injection channels extending therethrough, wherein the injection channels are configured to allow a potting to be injected through the injection channels and between the bottom shear plate and the tray panel.

16. The battery pack for a vehicle according to claim 15, wherein the housing contains a potting material encapsulating the plurality of battery cells and the channel tray and is bonded to the bottom shear plate and the upper shear plate.

17. A battery pack for a vehicle, comprising:
a housing including at least one pack vent between an interior and an exterior of the housing;
a plurality of battery cells disposed within the housing; and
a channel tray including channel arrays having a plurality of cell vent openings each positioned in connection with a vent on each of the plurality of battery cells and the channel arrays are in connection with the at least one vent of the housing, wherein the channel tray includes a plurality of panel assemblies each including a battery cell engagement panel and a tray panel, the battery cell engagement panels include the plurality of cell vent openings therein, the plurality of panel assemblies including having male engagement portions engaged with female engagement portions of an adjacent panel assembly.

18. The battery pack for a vehicle according to claim 17, wherein the housing includes a bottom shear plate and an upper shear plate, the battery cell engagement panel and the tray panel include passages extending therethrough, wherein the housing contains a potting material encapsulating the plurality of battery cells and the channel tray and is bonded to the bottom shear plate and the upper shear plate.

19. A battery pack for a vehicle, comprising:
a housing including at least one pack vent between an interior and an exterior of the housing;
a plurality of battery cells disposed within the housing; and
a channel tray including channel arrays having a plurality of vent openings each positioned in connection with a vent on each of the plurality of battery cells and the channel arrays are in connection with the at least one vent of the housing, wherein the channel system is enclosed from the rest of the volume of the pack and the plurality of vent openings are each provided with a vent cover, wherein the housing includes a bottom shear plate and an upper shear plate, wherein the housing contains a potting material encapsulating the plurality of battery cells and the channel tray and is bonded to the bottom shear plate and the upper shear plate.

20. The battery pack for a vehicle according to claim 19, wherein the housing includes a bottom shear plate and an upper shear plate, the battery cell engagement panel and the tray panel include passages extending therethrough, wherein the passages are configured to allow a potting to be injected through the passages and between the bottom shear plate and the tray panel.
